(19) United States
(12) Patent Application Publication
(10) Pub. No.: US 2005/0069052 A1
(43) Pub. Date: Mar. 31, 2005

(54) Ultra-wideband receiver

(76) Inventor: David Carbonari, San Diego, CA (US)

Correspondence Address: PULSE-LINK, INC., 1969 KELLOGG AVENUE, CARLSBAD, CA, 92008, US

(21) Appl. No.: 10/676,503

(22) Filed: Sep. 30, 2003

(51) Int. Cl. H04L 27/06

(52) U.S. Cl. 375/316

(57) ABSTRACT

An ultra-wideband receiver is provided. A receiver constructed according to one embodiment enables the simultaneous coexistence of ultra-wideband pulses with conventional carrier-wave signals. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to ultra-wideband communications. More particularly, the invention concerns an apparatus for receiving and demodulating ultra-wideband pulses for wire and wireless communications.

### BACKGROUND OF THE INVENTION

The Information Age is upon us. Access to vast quantities of information through a variety of different communication systems are changing the way people work, entertain themselves, and communicate with each other. For example, as a result of increased telecommunications competition mapped out by Congress in the 1996 Telecommunications Reform Act, traditional cable television program providers have evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as movies-on-demand and video teleconferencing demand high data transmission rates. Another example is interactive video in homes and offices. Moreover, traffic across the Internet continues to increase, and with the introduction of new applications, such as the convergence of voice and Internet data, traffic will only increase at a faster rate. Consequently, carriers and service providers are overhauling the entire network infrastructure—including switches, routers, backbone, and the last mile (i.e., the local loop)—in an effort to provide more bandwidth.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. The need for more bandwidth is evidenced by user complaints of slow Internet access and dropped data links that are symptomatic of network overload.

Therefore, there exists a need for an increase in the bandwidth of wire and wireless communication systems.

### SUMMARY OF THE INVENTION

The present invention provides an apparatus for receiving and demodulating an ultra-wideband signal. A receiver constructed according to the present invention can be configured to work in conjunction with wireless or wire communications mediums, whether the medium is twisted-pair wire, coaxial cable, fiber optic cable, or other types of wire media.

One embodiment of the present invention includes a device for receiving and demodulating an incoming ultra-wideband (UWB) communication signal. In this embodiment the signal is detected and demodulated and then the data is recovered.

One feature of the present invention is that UWB signals that are modulated using multi-level phase modulation and/or amplitude modulation may be demodulated by the receiver. The present invention may also demodulate pulse position modulated signals. These modulation techniques can significantly increase a data rate of a UWB communication system.

These and other features and advantages of the present invention will be appreciated from review of the following detailed description of the invention, along with the accompanying figures in which like reference numerals refer to like parts throughout.

### BRIEF DESCRIPTION OF THE DRAWING

The foregoing and other features, aspects and advantages are better understood from the following detailed description, appended claims, and accompanying drawings where:

FIG. 1 is an illustration of different communication methods;

FIG. 2 is an illustration of two ultra-wideband pulses;

FIG. 3 illustrates a conventional Costas loop;

FIG. 4 is an illustration of a receiver signal demodulator according to one embodiment of the invention;

FIG. 5 is an illustration of a local signal generator that is part of the receiver signal demodulator of FIG. 4;

FIG. 6 is a schematic block diagram of a method of demodulating ultra-wideband communications according to one embodiment of the invention;

FIG. 7 is a schematic block diagram of a method of generating first and second output signals according to one embodiment of the invention;

FIG. 8 is a schematic block diagram of a method of generating a difference signal according to one embodiment of the invention;

FIG. 9A is a schematic block diagram of a system for demodulating ultra-wideband communications according to one embodiment of the invention;

FIG. 9B is a schematic block diagram of an output signal generator according to one embodiment of the invention; and

FIG. 9C is a schematic block diagram of a difference signal generator according to one embodiment of the invention.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a method of receiving and demodulating a plurality of ultra-wideband pulses. The pulses may be transmitted and received wirelessly, or through any wire medium, whether the medium is twisted-pair wire, coaxial cable, fiber optic cable, or other types of wire media.

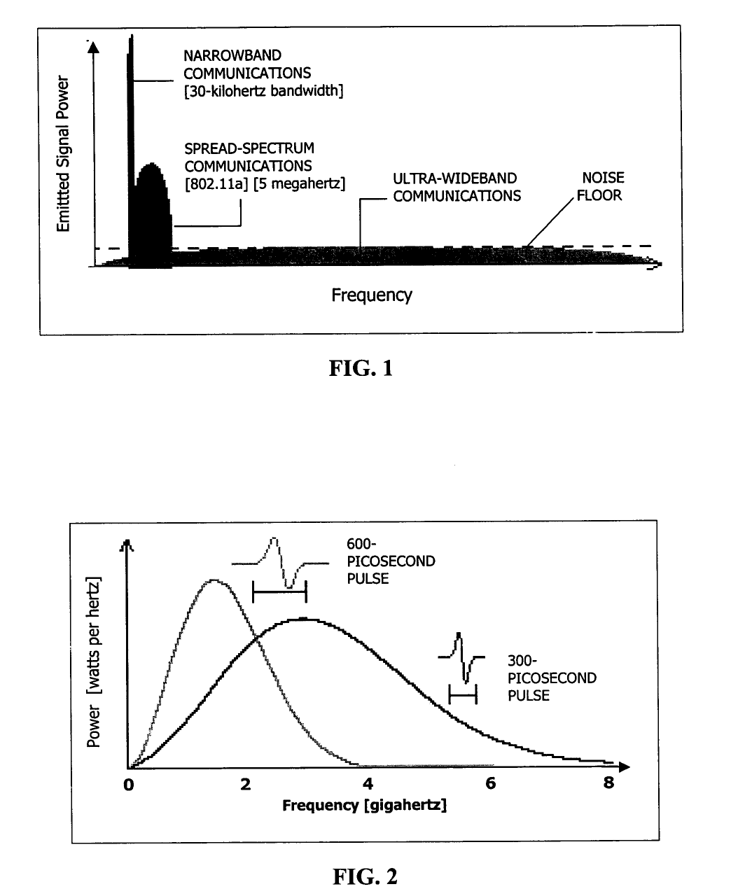

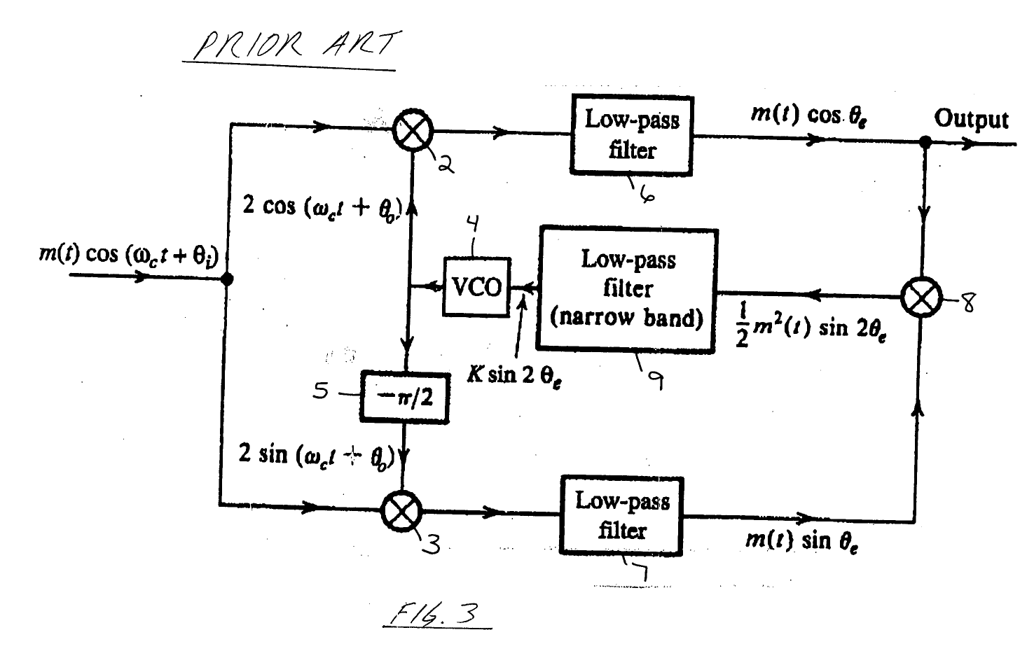

Referring to FIGS. 1 and 2, ultra-wideband (UWB) communication technology employs pulses of electromagnetic energy that are emitted at, for example, nanosecond or picosecond intervals (generally tens of picoseconds to a few nanoseconds in duration). For this reason, ultra-wideband is often called “impulse radio.” That is, the UWB pulses are transmitted without modulation onto a sine wave carrier frequency, in contrast with conventional radio frequency technology as described above. A UWB pulse is a single electromagnetic burst of energy. That is, a UWB pulse may be a single positive burst of electromagnetic energy, a single negative burst of electromagnetic energy or a single burst of electromagnetic energy with a predefined phase.

Alternate implementations of UWB can be achieved by mixing baseband pulses with a carrier wave that controls a center frequency of a resulting UWB signal. Ultra-wideband generally requires neither an assigned frequency nor a power amplifier.

An example of a conventional radio frequency technology is illustrated in FIG. 1. IEEE 802.11a, a wireless local area network (LAN) protocol, transmits radio frequency signals at a 5 GHz center frequency, with a radio frequency spread of about 5 MHz. A UWB pulse may have a 2.0 GHz center frequency, with a frequency spread of approximately 4 GHz, as shown in FIG. 2, which illustrates two typical UWB pulses. FIG. 2 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.2 GHz. Thus, UWB pulses generally do not operate within a specific frequency, as shown in FIG. 1. Because UWB pulses are spread across an extremely wide frequency range, UWB communication systems allow communications at very high data rates, such as 100 megabits per second or greater. According to one embodiment of the invention, the transmitter may be configured to transmit both carrier-wave signals and UWB signals. The carrier-wave signals and the UWB signals may be transmitted substantially simultaneously. The transmitter may include a carrier-wave transmitter portion that enables carrier-wave signals to be transmitted. A single antenna may be used for transmitting both the carrier-wave signals and the UWB signals.

Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), which is referred to and incorporated herein in its entirety by reference.

Also, because a UWB pulse is spread across an extremely wide frequency range, the power sampled at a single, or specific frequency is very low. For example, a UWB one-watt pulse of one nano-second duration spreads the one-watt over the entire frequency occupied by the UWB pulse. At any single frequency, such as at the carrier frequency of a CATV provider, the UWB pulse power present is one nano-watt (for a frequency band of 1 GHz). This is calculated by dividing the power of the pulse (i.e., 1 watt) by the frequency band (i.e., 1 billion Hertz). This is well within the noise floor of any communications system and therefore does not interfere with the demodulation and recovery of the signals transmitted by the CATV provider. Generally, a multiplicity of UWB pulses are transmitted at relatively low power (when sampled at a single, or specific frequency), for example, at less than −30 power decibels to −60 power decibels, which reduces interference with conventional radio frequencies. UWB pulses, however, transmitted through many wire media typically do not interfere with wireless radio frequency transmissions. Therefore, the power (sampled at a single frequency) of UWB pulses transmitted though wire media may range from about +30 dBm to about −140 dBm.

A plurality of ultra-wideband pulses may be transmitted to form a communication signal wherein one or more of the ultra-wideband pulses is used to represent data. These ultra-wideband pulses may be transmitted using a number of different signal modulation techniques, or methods.

The present invention may be employed in any type of network, be it wireless, wire, or a mix of wire media and wireless components. That is, a network may use both wire media, such as coaxial cable, and wireless devices, such as satellites, or cellular antennas. As defined herein, a network is a group of points or nodes connected by communication paths. The communication paths may be use wires or be wireless. A network as defined herein may interconnect with other networks and contain sub-networks. A network as defined herein may be characterized in terms of a spatial distance, for example, such as a local area network (LAN), a personal area network (PAN), a metropolitan area network (MAN), a wide area network (WAN), and a wireless personal area network (WPAN), among others. A network as defined herein may also be characterized by the type of data transmission technology in use on it, for example, a Transmission Control Protocol/Internet Protocol (TCP/IP) network, and a Systems Network Architecture network, among others. A network as defined herein may also be characterized by whether it carries voice signals, data signals, or both. A network as defined herein may also be characterized by users of the network, such as, for example, users of a public switched telephone network (PSTN) other type of public networks, and private networks (such as within a single room or home), among others. A network as defined herein may also be characterized by the usual nature of its connections, for example, a dial-up network, a switched network, a dedicated network, and a non-switched network, among others. A network as defined herein may also be characterized by the types of physical links that it employs, for example, optical fiber, coaxial cable, a mix of both, unshielded twisted pair, and shielded twisted pair, among others.

The present invention may also be employed in any type of wireless network, such as a wireless PAN, LAN, MAN, or WAN. The present invention may be implemented in a “carrier free” architecture, which does not require the use of high frequency carrier generation hardware, carrier modulation hardware, stabilizers, frequency and phase discrimination hardware or other devices employed in conventional frequency domain communication systems. The present invention dramatically increases the bandwidth of conventional networks that employ wire media, but can be inexpensively deployed without extensive modification to the existing wire media network.

In one embodiment, the present invention may provide increased bandwidth by injecting, or otherwise super-imposing an ultra-wideband (UWB) signal into an existing data signal and subsequently recovering the UWB signal at an end node, set-top box, subscriber gateway, or other suitable location.

One feature of the present invention is that it provides a receiver with the capability to demodulate various amplitude-, phase-, and timing-based modulation schemes. According to one embodiment, the present invention uses a modified “Costas Loop.” A typical, conventional Costas Loop, shown in FIG. 3, is used to generate a local carrier. An incoming signal may be expressed as m(t) cos(ω_{c}t+θₜ). The incoming signal is split into two duplicate signals with one being expressed as a Sine wave and the other as a Cosine wave. The Sine and Cosine waves are each transmitted to mixers 2, 3. The mixers 2, 3 multiply the incoming signal by a local signal generated by a voltage controlled oscillator 4. The voltage controlled oscillator (VCO) generates a local signal expressed as cos(ω_{c}t+θₒ). The Sine wave, however, is multiplied by a phase delayed signal due to phase delay 5. A phase error may be expressed as ✓ₑ=✓ᵢ−✓ₒ. The products are then transmitted to low-pass filters 6, 7. The low-pass filters 6,7 may be used to attenuate a high frequency component of the signal to yield outputs expressed as m(t) cos [symbol] and m(t) sin [symbol] , respectively.

Again referring to FIG. 3, outputs from the low-pass filters 6 and 7 may be further multiplied to yield m²(t) sin 2 [symbol] using a mixer 8. Output from the mixer 8 is then transmitted to a narrow-band low-pass filter. Passing this output through a narrow-band low-pass filter results in an output that may be expressed as k sin 2✓ₑ, where k is a direct current component of m²(t)/2. A signal expressed as k sin 2✓ₑ, is applied to an input of the voltage controlled oscillator with quiescent frequency [symbol] _{c}. The input k sin 2✓ₑ increases an output frequency which, in turn, reduces ✓ₑ.

Although the present invention uses Costas Loop elements, a different demodulator circuit, having different functionality, results. For example, the present invention uses slicers that receive output from the low-pass filters 2 and 3 that enable a determination to be made whether more than two (2) phases are present in a signal. This enables the demodulator to discriminate, for example, 4-phases, 8-phases, 16-phases, or any multiple thereof. The slicers also enable demodulation of amplitude modulated signals, if amplitude modulation is present in the incoming signal. Conventional Costas Loops do not provide this functionality.

Another difference between a conventional Costas Loop and the present invention is that the present invention uses a voltage controlled oscillator that is gated by the incoming signal. In a conventional Costas Loop, the voltage controlled oscillator is not gated and simply consumes power continuously. In the present invention, the voltage controlled oscillator is turned on by the incoming signal when it is received.

The voltage controlled oscillator (i.e., local signal generator) in a conventional Costas Loop typically uses a phase-locked loop. According to one embodiment of the present invention, the local signal generator does not include a phase-locked loop. The present invention uses a frequency multiplier instead of the phase-locked loop. These distinctions are described in further detail below. Additionally, Costas Loops have not been used for demodulating ultra-wideband communication signals.

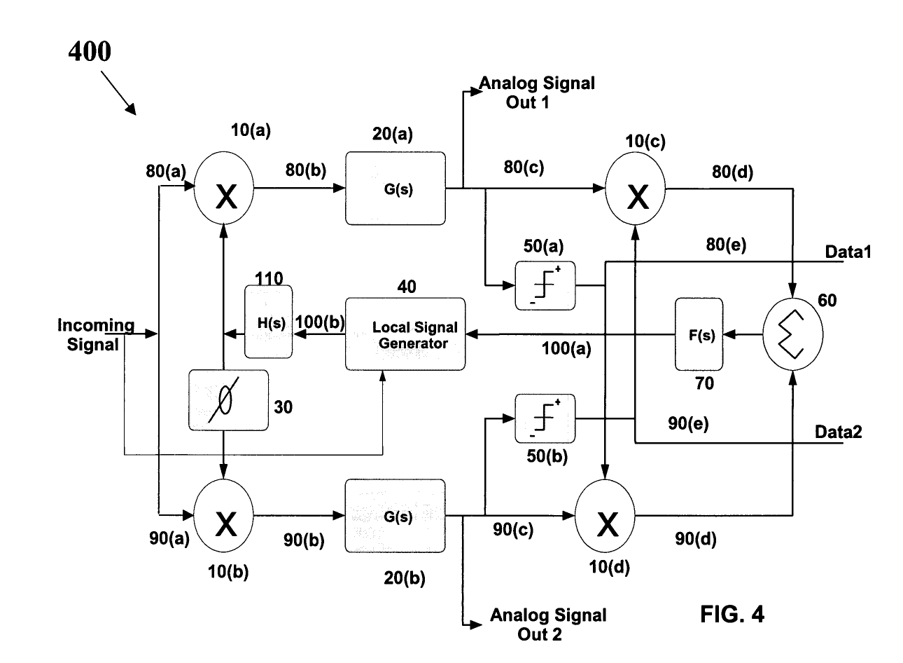

FIG. 4 illustrates a signal demodulator 400 constructed according to one embodiment of the present invention. The signal demodulator 400 comprises part of a receiver that also includes other components, such as one or more antennas, amplifiers and filters. It will be appreciated that other components may be included within the receiver.

The signal demodulator 400 of the present invention enables a receiver to demodulate various amplitude-, phase-, and timing-based modulation schemes.

As shown in FIG. 4, an incoming signal is split into two signals 80(a) and 90(a). The incoming signal may be represented by a time-limited sinusoidal signal having a center frequency ω_{c} and a phase θ. In other words, the incoming signal is approximated by cos(ω_{c}t+θ) during an active signal duration. A local signal generator 40 generates a local signal 100(b) that has the same frequency and a potentially different phase φ of the incoming signal. The local signal 100(b) may be characterized as cos(ω_{c}t+φ). The local signal 100(b) is filtered by a matched filter 110, and the filtered signal is split into two (2) duplicate signals. One of the duplicate signals is multiplied by the incoming signal using a first mixer 10(a). The other duplicate signal is phase shifted by a phase delay element 30. Preferably, the phase delay element 30 is configured to impart a π/2 phase delay to the other duplicate signal of the local signal 100(b). Preferably, the phase delay element may be a 90-degree phase delay circuit or a 270-degree phase delay circuit. This results in a signal represented by sin(ω_{c}t+φ). This is a phase delayed signal. The phase delayed signal is multiplied by the incoming signal using a second mixer 10(b). An output signal 80(b) from the first mixer 10(a) may be expressed as cos(ω_{c}t+θ)cos(ω_{c}t+φ), which is equivalent to

$$\frac{1}{2} cos ( θ - ϕ ) + \frac{1}{2} cos ( 2 {ω}_{c} t + ω + ϕ ) .$$

Likewise, a signal 90(b) may be represented as

$$\frac{1}{2} sin ( θ - ϕ ) + \frac{1}{2} sin ( 2 {ω}_{c} t + θ + ϕ ) .$$

The two (2) signals 80(b) and 90(b) are then sent to filters 20(a) and 20(b), respectively. The filters 20(a) and 20(b) have similar transfer functions G(s). The filters 20(a) and 20(b) may be designed with cutoff frequencies low enough to significantly attenuate the high frequency components

$$\frac{1}{2} cos ( 2 {ω}_{c} t + ω + ϕ ) and \frac{1}{2} sin ( 2 {ω}_{c} t + ω + ϕ ) .$$

Resulting signals 80(c) and 90(c) then become

$$\frac{1}{2} cos ( θ - ϕ ) and \frac{1}{2} sin ( θ - ϕ ) ,$$

respectively. The signals 80(c) and 90(c) are then split into two (2) duplicate signals. One of the duplicate signals is transmitted to the quantizers 50(a) and 50(b). Another copy of signals 80(c) and 90(c) are sent to mixers 10(c) and 10(d). Quantizers 50(a) and 50(b) quantize the signal into signals 80(e) and 90(e) which are discrete levels representing data. In one embodiment of the present invention, the quantizers 50(a) and 50(b) may be μ-law quantizers (also known as mu-Law). Generally, the μ-law quantizer samples at a finer granularity for smaller deviations and coarser granularity for larger deviations. This places finer resolution in the ranges where the deviation in phase is smaller and fewer samples when the phase deviation is larger. This is useful in phase discrimination and enables more accurate demodulation in modulation systems employing a greater number of phases.

The output of the quantizers is transmitted to the mixers 10(c) and 10(d) for the opposite channel. The resultant products, signals 80(d) and 90(d), are sent to a summer 60 which calculates an algebraic difference between the signals 80(d) and 90(d). A resulting difference signal is transmitted to a filter 70, which filters the difference signal and provides an error signal 100(a) to the local signal generator 40.

Preferably, the matched filter 110 is matched to an output filter of a corresponding transmitter. By matching the transfer function of these two filters, the signal demodulator 400 provides for correlation between signals generated by the corresponding transmitter and the receiver constructed according to the present invention. Narrowband interfering signals present within the bandwidth of the communication system will be significantly attenuated by matched filter 110, thereby decreasing any interference with signal recovery. This is because matched filter 110 is approximating the signal expected without the narrowband interference. In the presence of narrowband interference the signal will be distorted by the interference signal. The signals 80(b) and 90(b) output from mixers 10(a) and 10(b) will have components in both high and low frequency ranges due to the interference. Filters 20(a) and 20(b) will eliminate a significant portion of the interference by eliminating the high frequency components. The low frequency component of the interference signal results in a lower correlation amplitude in signal 80(c) and 90(c). This is resolved by quantizers 50(a) and 50(b).

Outputs labeled “Analog Signal Out 1” and “Analog Signal Out 2” contain both the amplitude and phase of the incoming signal. In one embodiment of the present invention, amplitude demodulation circuits (not shown) may be connected to the Analog Signal Out 1 and the Analog Signal Out 2. In this embodiment, the amplitude demodulation circuits are capable of detecting and demodulating amplitude variation as well. For example, an amplitude demodulation circuit that may be used in conjunction with the present invention comprises an envelope detector and an analog to digital converter. In this embodiment, the envelope detector provides a lower frequency signal representative of the amplitude. The analog to digital converter detects and digitizes the various amplitude variations in the signal. A number of amplitude demodulation techniques are known in the art and may be used to practice this aspect of the present invention.

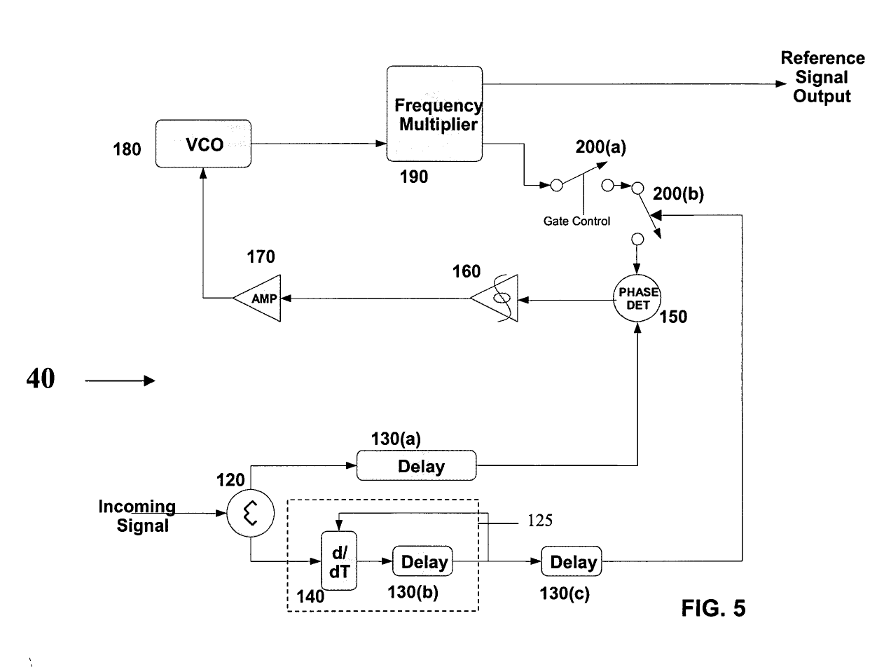

FIG. 5 illustrates one embodiment of the local signal generator 40 shown in FIG. 4. The local signal generator 40 may be constructed as described below, or it may comprise other arrangements of components. One feature of this aspect of the invention is that the local signal generator 40 is activated when a signal is received, and is deactivated when no signal is present. This reduces power consumption in a receiver that includes the local signal generator 40. It will be appreciated that other arrangements of components may be constructed to achieve the same functionality, and that these other arrangements fall within the scope of this aspect of the present invention.

As shown in FIG. 5, the local signal generator 40 is gated by the presence of an incoming signal or additionally by a gate control signal, which may be provided by a computer microprocessor or a finite state machine. A splitter 120 divides the incoming signal into two duplicate signals. One duplicate signal is connected to a delay 130(a), which is configured to impart a delay to a rising edge of the incoming signal. The delay 130(a) shapes the incoming signal to occupy one data time slot. The other duplicate signal is transmitted to a one shot circuit 125 that includes a differentiating element 140 and a delay element 130(b). The other duplicate signal may be further delayed by a delay element 130(c). The other duplicate signal is then transmitted to a gate 200(b) to actuate the gate 200(b). In this manner, the local signal generator 40 is active when a signal is received and deactivated when there is no signal, or when no signal is present.

An optional gate 220(a) permits external circuit control of signal generation. The Gate Control signal for the gate 200(a) may be provided by a finite state machine or a microprocessor. When the gate 200(b) and the optional gate 200(a) are both in a closed position, a phase detector 150 compares an output of a frequency multiplier 190 with the output of a delay 130(a). A difference detected between these two signals is then integrated by an integrating amplifier 160. An additional amplifier 170 may be used to increase the amplitude of the integrated signal. The output of the additional amplifier 170, or alternatively, the integrating amplifier 160, is the control signal for a voltage controlled oscillator (VCO) 180. In one embodiment, the VCO 180 may be a temperature compensated VCO. The frequency multiplier 190 preferably multiplies a frequency of an output of the VCO 180 by an integer factor.

This is because the output frequency of frequency multiplier 190 controls the time resolution of the receiver's sampling time period. This time resolution controls the receiver's communication data rate in that the locally generated signal needs to fall within a single time slot of the sampling time. For example, VCO 180 may be producing a 125 MHz signal, and frequency multiplier 190 may multiply this signal by an integer factor of 20 producing a 2.5 GHz signal. A 2.5 GHz signal resolves to a sampling time period of 400 picoseconds, thus allowing the receiver to sample every 400 picoseconds. Alternatively, the VCO 180 may produce a 100 MHz signal, which may be multiplied by 25 in frequency multiplier 190, which would produce the same 2.5 GHz signal with the same 400 picosecond sampling period. Thus, the integer factor may be selected from any one of a large number of integers, but in a preferred embodiment the integer factor is 20.

The output signal of the VCO 180 is transmitted to the frequency multiplier 190. The frequency multiplier 190 multiplies the output of the VCO 180 to achieve a higher frequency signal. The frequency multiplier 190 provides one output as a reference signal to the above-discussed demodulator. Additionally, the frequency multiplier 190 outputs back to the optional gate 200(a) for continued operation.

One feature of the present invention is that communication signals employing Pulse Position Modulation (PPM) can be demodulated. Specifically, PPM uses groups of “time bins” where an ultra-wideband pulse may be located. Data is encoded by the location of one or more ultra-wideband pulse(s) in one or more specific time bins. Because the local signal generator 40 may be synchronized to within the time duration of a single time bin, a communication signal employing PPM modulation can be demodulated. In addition, the ability of the local signal generator 40 to “gate on” when the incoming signal is present allows the demodulation of PPM signals as well as the generation of the local signal.

Because the signal demodulator 400, and the local signal generator 40, described herein are capable of demodulation of both the phase and the time of arrival of an incoming signal, and can be used with amplitude demodulation circuits, they are capable of demodulation of a variety of different signal modulation methods.

An ultra-wideband communication system employing devices and methods described herein may transmit and receive data comprised of a plurality of ultra-wideband pulses that form a communication signal wherein one or more of the ultra-wideband pulses is used to represent data. That is, ultra-wideband pulse modulation techniques enable a single representative data symbol (such as one or more ultra-wideband pulses) to represent a plurality of binary digits, or bits. This has an advantage of increasing the data rate in a communication system. These ultra-wideband pulses may be transmitted using a number of different signal modulation techniques, or methods.

For example, one signal modulation method is ternary modulation. Ternary modulation is described in co-pending U.S. patent application Ser. No. 10/425,936, entitled “ULTRA-WIDEBAND PULSE MODULATION SYSTEM AND METHOD” filed Apr. 28, 2003. Other examples of signal modulation methods are: Pulse Width Modulation (PWM), Pulse Amplitude Modulation (PAM), and Pulse Position Modulation (PPM). In PWM, a series of predefined UWB pulse widths are used to represent different sets of bits. For example, in a system employing 8 different UWB pulse widths, each symbol could represent one of 8 combinations. This symbol would carry 3 bits of information. In PAM, predefined UWB pulse amplitudes are used to represent different sets of bits. A system employing PAM16 would have 16 predefined UWB pulse amplitudes. This system would be able to carry 4 bits of information per symbol. In a PPM system, predefined positions within a UWB pulse timeslot are used to carry a set of bits. A system employing PPM16 would be capable of carrying 4 bits of information per symbol.

Other UWB pulse modulation techniques may include: Coded Recurrence Modulation (CRM); Sloped Amplitude Modulation (SLAM); and 1-pulse modulation.

In some conventional ultra-wideband (UWB) modulation techniques, a doublet or wavelet “chip” is modulated by a data signal. The data signal imparts a phase to the chip. A “doublet” or “wavelet” in some instances is a positive UWB pulse followed by a negative UWB pulse, or vice-versa. The two UWB pulses include a single chip, which is the smallest element of data in a modulated signal. In this case, the chip, comprising the two UWB pulses, represents a single bit of data (a 1 or a 0). If the data bit being sent is a 0, the chip may start with a positive UWB pulse and end with a negative UWB pulse, and if the data bit being sent is a 1, the chip may start with a negative UWB pulse and end with a positive UWB pulse. For example, in a bi-phasic or antipodal system, the two-pulse “wavelet” or “doublet” or its inverse (180° phase shift) represents a 1 or a 0. Other phase shifts may also be used such as 0°, 90°, 180°, and 270° shifts to develop quad-phasic systems. One element common to these modulation techniques, however, is that a 0 or 1 is represented by at least a positive and a negative pulse of energy. In the bi-phasic or antipodal system described above, a 0 is represented by two pulses of energy—a positive pulse and a negative pulse (or vice-versa). Thus, conventional modulation techniques use energy in the form of at least two UWB pulses having a specific phase (positive or negative) to send each data bit.

One embodiment of the present invention provides a receiver that increases an available bandwidth of a communication system by enabling the simultaneous transmission of conventional carrier-wave signals and ultra-wideband (UWB) pulses. One method includes transmitting at least one data symbol with every UWB pulse. The data symbol may represent one or more binary digits, or bits.

In contrast, conventional UWB communication systems transmit multiple UWB pulses to represent one data symbol. Thus, one feature of the present invention is that the average energy transmitted into the radio frequency (RF) spectrum is reduced. This reduces the possibility of interfering with conventional RF signals, and alternatively, in another embodiment of the present invention, may allow the power of each ultra-wideband pulse to be increased. Another feature of the present invention is that the transmitted ultra-wideband pulses can have a spectral power density that does not cause interference with conventional RF signals.

The UWB pulse reception and demodulation method of the present invention enables the simultaneous coexistence of the ultra-wideband pulses with conventional carrier-wave signals. The present invention may be used in wireless and wire communication networks such as hybrid fiber-coax networks.

Thus, the methods of the present invention enable an increase in the bandwidth, or data rates of a communication system.

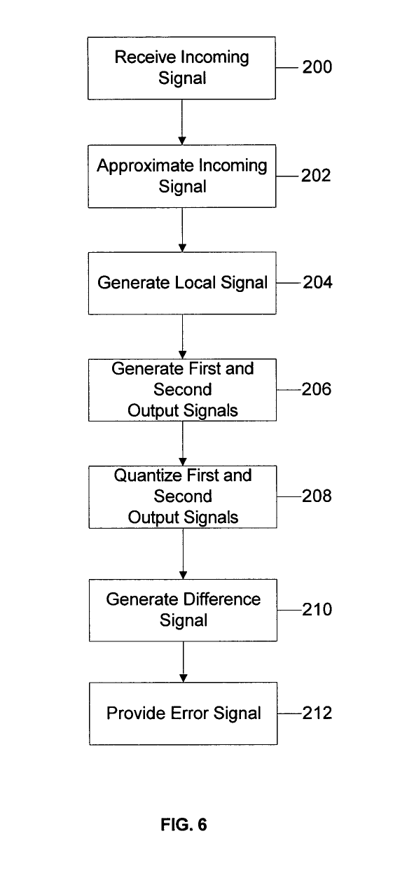

FIG. 6 illustrates a method of demodulating ultra-wideband communications according to one embodiment of the invention. An incoming ultra-wideband signal, transmitted from an ultra-wideband transmitter may be received at an ultra-wideband receiver using an antenna, in step 200. An approximation of the incoming signal may be made by representing the incoming signal as a time-limited sinusoidal signal having a predetermined center frequency and phase, in step 202. The approximation may be made during an active signal duration. A local signal having the same frequency and a potentially different phase may be generated, in step 204. The local signal may be used to generate first and second output signals, in step 206.

The first and second output signals may then be quantized, in step 208. A difference signal that represents a difference between the first and second output signals quantized may be generated, in step 210. Quantizing the first and second output signals subdivides the signals into discrete levels representing data. An error signal, based on the difference signal, may then be generated, in step 212. The error signal may be a filtered difference signal.

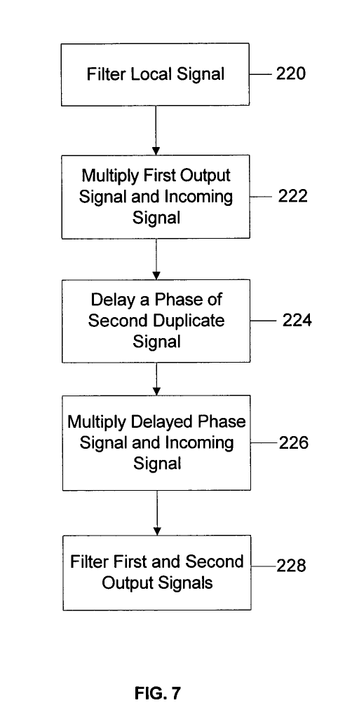

FIG. 7 illustrates a method of generating the first and second output signals according to one embodiment of the invention. The local signal may be filtered and split into two (2) duplicate signals, in step 220. Preferably, a filter used to filter the local signal is a matched to an output filter of the ultra-wideband transmitter. The filters are matched by matching transfer functions of both filters. This enables a demodulator to provide a correlation between signals generated by the ultra-wideband transmitter and the ultra-wideband receiver. In a preferred embodiment, the matched filter is a band-pass filter having a center frequency of approximately five (5) gigahertz and a passband of approximately three (3) gigahertz. It will be appreciated that other center frequencies and passbands may be employed.

One of the duplicate signals may be multiplied by the incoming signal, in step 222, resulting in a first output signal. A phase of the other duplicate signal may be delayed, in step 224, resulting in a delayed phase signal. The delayed phase signal may be multiplied by the incoming signal, in step 226, producing a second output signal. The first and second output signals may then be filtered, in step 228. The filtered first and second output signals may be quantized as described above.

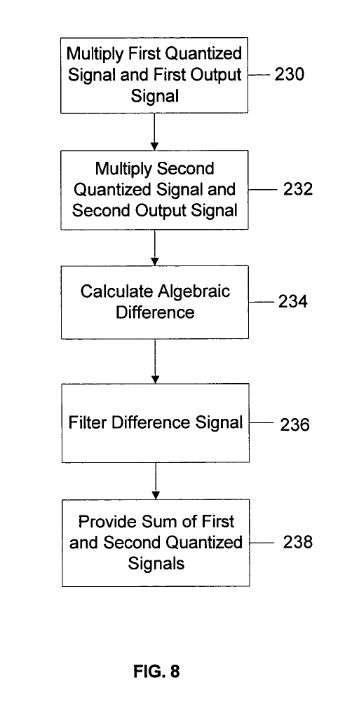

FIG. 8 illustrates a method of generating a difference signal according to one embodiment of the invention. After quantizing the first and second output signals, the first quantized signal may be multiplied by the first output signal, in step 230, and the second output signal may be multiplied by the second output signal, in step 232. The resulting signals may be transmitted to a summer. The summer may be used to calculate an algebraic difference between the resulting signals, in step 234. The algebraic difference may be represented by a difference signal. The difference signal may then be filtered.

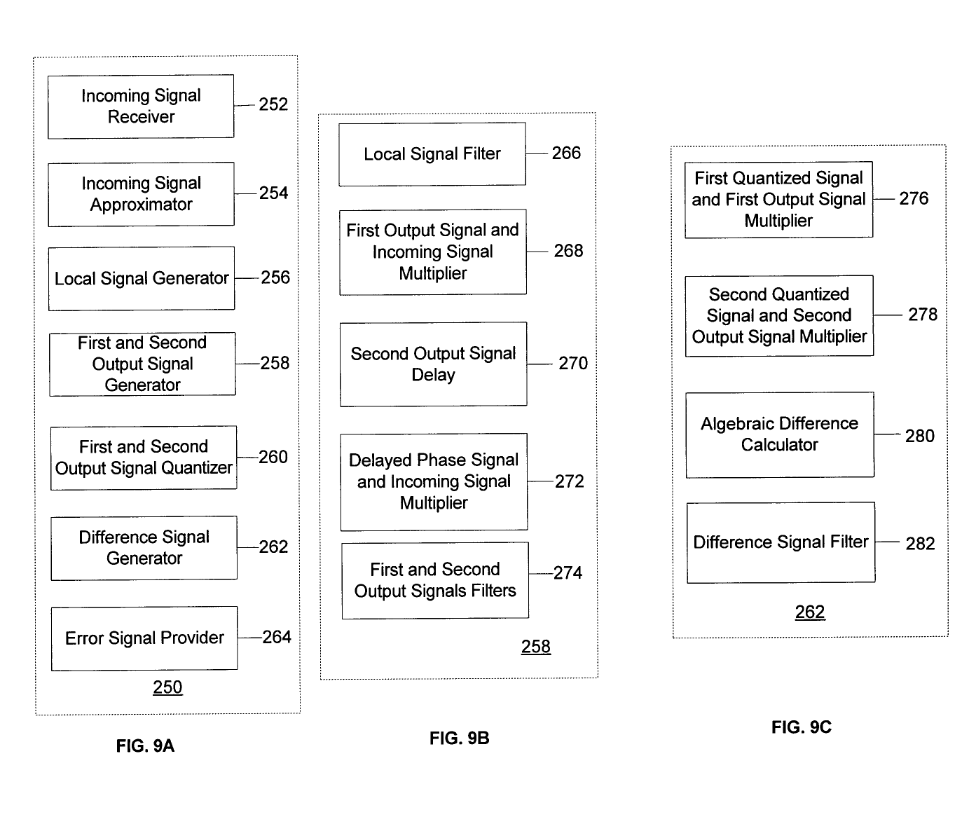

FIG. 9A illustrates a system 250 for modulating ultra-wideband signals according to one embodiment of the invention. The system 250 may include an incoming signal receiver 252, incoming signal approximator 254, local signal generator 256, first and second output signal generator 258, first and second output signal quantizer 260, difference signal generator 262, and error signal provider 264. An incoming signal may be received by the incoming signal receiver 252. The incoming signal may be an electromagnetic communication signal. The incoming signal may be, for example, a plurality of ultra-wideband pulses or a conventional carrier-wave signal.

The incoming signal approximator 254 approximates the incoming signal by representing the incoming signal as a time-limited sinusoidal signal having a predetermined center frequency and phase. The incoming signal is preferably approximated during an active signal duration. A local signal may be generated by the local signal generator 256. According to one embodiment, the local signal generator is a phase-locked loop (PLL), or the local signal generator 40, described above. The local signal generator 256 generates a local signal that has the same frequency and a potentially different phase of the incoming signal. First and second output signals may be generated based on the incoming signal and the local signal by the first and second output signal generator 258. The first and second output signals may then be quantized by the first and second output signal quantizer 260. The first and second output signal quantizer 260 subdivides the first and second output signals into discrete levels representing data. A difference signal may be generated based on the first and second output signals quantized by the difference signal generator 262. The difference signal generator 262 may be a summer that calculates an algebraic difference between the first and second output signals. An error signal based on the difference signal may then be provided using error signal provider 264.

FIG. 9B illustrates the first and second output signal generator 258 according to one embodiment of the invention and shown in FIG. 9A. The first and second output signal generator 258 may include a local signal filter 266, first output signal and incoming signal multiplier 268, second output signal delay 270, delayed phase signal and incoming signal multiplier 272, and first and second output signals filters 274. The local signal filter 266 is preferably a band-pass filter having a transfer function that matches a transfer function of an ultra-wideband transmitter that transmitted the incoming signal. The band-pass filter preferably has a passband of approximately 5 gigahertz. The passband preferably has a center frequency of about 3 gigahertz, although other passbands and center frequencies may be used.

The local signal filter 266 filters the local signal and produces first and second output signals. The first and second output signals are duplicates of the filtered local signal. The first output signal and the incoming signal are multiplied using first output signal and incoming signal multiplier 268. The second output signal may be phase delayed by the second output signal delay 270 to produce a delayed phase signal. Preferably, the second output signal is phase-shifted by 90 degrees or 270 degrees. The delayed phase signal and the incoming signal may then be multiplied by the delayed phase signal and incoming signal multiplier 272.

The first and second output signals that are outputs of the first output signal and incoming signal multiplier 268 and the delayed phase signal and incoming signal multiplier 272 may then be filtered by the first and second output signals filters 274. The filters 274 are preferably low-pass filters.

FIG. 9C illustrates the difference signal generator 262 according to one embodiment of the invention and shown in FIG. 9A. The difference signal generator 262 may include a first quantized signal and first output signal multiplier 276, second quantized signal and second output signal multiplier 278, algebraic difference calculator 280, and difference signal filter 282.

The difference signal generator 262 receives quantized first and second output signals from the first and second output signal quantizer 260. The first quantized signal and the first output signal may be multiplied by the first quantized signal and first output signal multiplier 276. The second quantized signal and the second output signal may be multiplied by the second quantized signal and second output signal multiplier 278. Output from the first quantized signal and first output signal multiplier 276 and the second quantized signal and second output signal multiplier 278 may be transmitted to an algebraic difference calculator 280. The algebraic difference calculator 280 may be a summer that sums the first and second quantized signals to determine a difference between the first and second quantized signals. The difference may be represented as a difference signal. The difference signal may then be transmitted to a difference signal filter 282. The difference signal filter 282 is preferably a low-pass filter.

Thus, it is seen that an apparatus for receiving and demodulating transmitting electromagnetic pulses, such as ultra-wideband pulses, is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the instant disclosure, and the present invention is limited only by the instant disclosure. It is noted that various equivalents for the particular embodiments discussed in this description may practice the invention as well.

1. A method of demodulating an ultra-wideband communication signal, the method comprising the steps of:
receiving an incoming signal, wherein the incoming signal comprises a plurality of ultra-wideband pulses;
approximating the incoming signal;
generating a local signal;
generating a first output signal and a second output signal;
quantizing the first output signal and the second output signal to produce a first quantized signal and a second quantized signal;
generating a difference signal for the first quantized signal and the second quantized signal; and
providing an error signal based on the difference signal.

2. The method of claim 1, wherein the step of generating a local signal uses a phase-locked loop.

3. The method of claim 2, wherein the phase-locked loop is gated.

4. The method of claim 3, wherein the phase-locked loop is gated by the incoming signal.

5. The method of claim 1, wherein the step of generating a first output signal and a second output signal comprises:
filtering the local signal to produce a first duplicate signal and a second duplicate signal.

6. The method of claim 5, wherein the filtering uses a plurality of low-pass filters.

7. The method of claim 6, wherein a cut-off frequency of the plurality of low-pass filters is approximately equal.

8. The method of claim 7, wherein the cut-off frequency is approximately 3 gigahertz.

9. The method of claim 5, wherein the filtering uses a matched filter.

10. The method of claim 9, wherein the matched filter comprises a band-pass filter.

11. The method of claim 10, wherein a passband of the band-pass filter is approximately 3 gigahertz.

12. The method of claim 11, wherein a center frequency of the passband is approximately 5 gigahertz.

13. The method of claim 10, wherein a transfer finction of the bandpass filter approximates a transfer function of an ultra-wideband transmitter transmitting the incoming signal.

14. The method of claim 1, wherein the generating a first output signal and a second output signal comprises:
multiplying a first duplicate signal and the incoming signal to produce a first output signal.

15. The method of claim 14, wherein the step of generating a first output signal and a second output signal comprises:
delaying a phase of a second duplicate signal to produce a delayed phase signal.

16. The method of claim 15, wherein the step of delaying uses a delay circuit from the group consisting of a 90-degree phase delay circuit and a 270-degree phase delay circuit.

17. The method of claim 15, wherein the step of delaying imparts a delay to a rising edge of the incoming signal.

18. The method of claim 17, wherein the step of delaying shapes the incoming signal to approximately a one bit time duration.

19. The method of claim 1, wherein the step of generating a first output signal and a second output signal comprises:
multiplying a delayed phase signal and the incoming signal to produce a second output signal.

20. The method of claim 1, wherein the step of generating a first output signal and a second output signal comprises:
filtering the first output signal and the second output signal.

21. The method of claim 1, wherein the step of generating a difference signal comprises:
multiplying a first quantized signal with the first output signal.

22. The method of claim 1, wherein the step of generating a difference signal comprises:
multiplying a second quantized signal with the second output signal.

23. The method of claim 1, wherein the step of generating a difference signal comprises:
calculating an algebraic difference between the first quantized signal and the second quantized signal.

24. The method of claim 1, wherein the step of generating a difference signal comprises:
filtering the difference signal.

25. The method of claim 1, wherein the step of quantizing the first output signal and the second output signal uses at least one multi-level quantizer.

26. The method of claim 25, wherein the at least one multi-level quantizer is selected from a group consisting of: a μ-law quantizer, a 4 level quantizer, a 8 level quantizer, and a 16 level quantizer.

27. The method of claim 1, wherein each of the plurality of ultra-wideband pulses has a duration ranging from about 10 picoseconds to about 1 millisecond.

28. The method of claim 1, wherein each of the plurality of ultra-wideband pulses has at least one of a phase and an amplitude that conveys data.

29. An ultra-wideband receiver, comprising:
a receiver structured to receive an incoming signal, wherein the incoming signal comprises a plurality of ultra-wideband pulses;
an approximator structured to approximate the incoming signal;
a local signal generator structured to generate a local signal;
an output signal generator structured to generate a first output signal and a second output signal;
a quantizer structured to quantize the first output signal and the second output signal to produce a first quantized signal and a second quantized signal;
a difference signal generator structured to generate a difference signal for the first quantized signal and the second quantized signal; and
an error provider structured to provide an error signal based on the difference signal filtered.

30. The ultra-wideband receiver of claim 29, wherein the local signal generator uses a phase-locked loop.

31. The ultra-wideband receiver of claim 30, wherein the phase-locked loop is gated.

32. The ultra-wideband receiver of claim 31, wherein the phase-locked loop is gated by the incoming signal.

33. The ultra-wideband receiver of claim 30, wherein the output generator comprises:
a local signal filter that produces a first duplicate signal and a second duplicate signal.

34. The ultra-wideband receiver of claim 33, wherein the local signal filter comprises a plurality of low-pass filters.

35. The ultra-wideband receiver of claim 34, wherein a cut-off frequency of the low-pass filter is approximately equal.

36. The ultra-wideband receiver of claim 35, wherein the cut-off frequency is approximately 3 gigahertz.

37. The ultra-wideband receiver of claim 33, wherein the local signal filter comprises a matched filter.

38. The ultra-wideband receiver of claim 37, wherein the matched filter comprises a band-pass filter.

39. The ultra-wideband receiver of claim 38, wherein a passband of the band-pass filter is approximately 3 gigahertz.

40. The ultra-wideband receiver of claim 39, wherein a center frequency of the passband is approximately 5 gigahertz.

41. The ultra-wideband receiver of claim 38, wherein a transfer function of the bandpass filter approximates a transfer function of an ultra-wideband transmitter transmitting the incoming signal.

42. The ultra-wideband receiver of claim 29, wherein the output generator comprises:
a first multiplier that multiplies the first duplicate signal and the incoming signal to produce a first output signal.

43. The ultra-wideband receiver of claim 29, wherein the output signal generator comprises:
a phase delayer that delays a phase of the second duplicate signal to produce a delayed phase signal.

44. The ultra-wideband receiver of claim 43, wherein the phase delayer is selected from a group consisting of: a 90-degree phase delay circuit, and a 270-degree phase delay circuit.

45. The ultra-wideband receiver of claim 43, wherein the phase delayer imparts a delay to a rising edge of the incoming signal.

46. The ultra-wideband receiver of claim 45, wherein the delay shapes the incoming signal to approximately a one bit time duration.

47. The ultra-wideband receiver of claim 29, wherein the output signal generator comprises:
a second multiplier that multiplies the delayed phase signal and the incoming signal to produce a second output signal.

48. The ultra-wideband receiver of claim 29, wherein the output signal generator comprises:
an output signal filter that filters the first output signal and the second output signal.

49. The ultra-wideband receiver of claim 29, wherein the difference signal generator comprises:
a third multiplier that multiplies a first quantized signal with the first output signal.

50. The ultra-wideband receiver of claim 29, wherein the difference signal generator comprises:
a fourth multiplier that multiplies a second quantized signal with the second output signal.

51. The ultra-wideband receiver of claim 29, wherein the difference signal generator comprises:
a difference calculator that calculates an algebraic difference between the first quantized signal and the second quantized signal.

52. The ultra-wideband receiver of claim 29, wherein the difference signal generator comprises:
a difference signal filter that filters the difference signal.

53. The ultra-wideband receiver of claim 29, wherein the quantizer uses a multi-level quantizer.

54. The ultra-wideband receiver of claim 53, wherein the multi-level quantizer is selected from a group consisting of: a μ-law quantizer, a 4 level quantizer, a 8 level quantizer, and a 16 level quantizer.

55. The ultra-wideband receiver of claim 29, wherein each of the plurality of ultra-wideband pulses has a duration from about 10 picoseconds to about 1 millisecond.

56. The ultra-wideband receiver of claim 29, wherein each of the plurality of ultra-wideband pulses has at least one of a phase and an amplitude that conveys data.

57. A system of demodulating ultra-wideband communications comprising:
means for receiving an incoming signal, wherein the incoming signal comprises a plurality of ultra-wideband pulses;
means for approximating the incoming signal;
means for generating a local signal;
means for generating a first output signal and a second output signal;
means for quantizing the first output signal and the second output signal to produce a first quantized signal and a second quantized signal;
means for generating a difference signal for the first quantized signal and the second quantized signal; and
means for providing an error signal based on the difference signal.
